(19) United States
(12) Patent Application Publication
(10) Pub. No.: US 2023/0362574 A1
(43) Pub. Date: Nov. 9, 2023

(54) METHOD OF RENDERING OBJECT-BASED AUDIO AND ELECTRONIC DEVICE PERFORMING THE METHOD

(71) Applicant: Electronics and Telecommunications Research Institute, Daejeon (KR)

(72) Inventors: Yong Ju LEE, Daejeon (KR); Jae-hyoun YOO, Daejeon (KR); Dae Young JANG, Daejeon (KR); Kyeongok KANG, Daejeon (KR); Soo Young PARK, Daejeon (KR); Tae Jin LEE, Daejeon (KR); Young Ho JEONG, Daejeon (KR)

(73) Assignee: Electronics and Telecommunications Research Institute, Daejeon (KR)

(21) Appl. No.: 18/320,729

(22) Filed: May 19, 2023

(30) Foreign Application Priority Data
May 5, 2022 (KR) 10-2022-0062101
Jul. 12, 2022 (KR) 10-2022-0085786
Dec. 6, 2022 (KR) 10-2022-0168865

(51) Int. Cl. H04S 7/00; G06F 3/16

(52) U.S. Cl. CPC H04S 7/303; G06F 3/165; H04S 2420/01; H04S 2400/11

(57) ABSTRACT

A method of rendering object-based audio and an electronic device performing the method are disclosed. The method includes identifying metadata of object-based audio, identifying an audio source distance between the object-based audio and a listener using the metadata, determining a minimum distance of the object-based audio to apply attenuation according to the audio source distance, based on a reference distance of the object-based audio in the metadata, and rendering the object-based audio using the audio source distance and the minimum distance.

### CROSS-REFERENCE TO RELATED APPLICATIONS

This application claims the benefit of Korean Patent Application No. 10-2022-0062101 filed on May 20, 2022, Korean Patent Application No. 10-2022-0085786 filed on Jul. 12, 2022, and Korean Patent Application No. 10-2022-0168865 filed on Dec. 6, 2022, in the Korean Intellectual Property Office, the entire disclosures of which are incorporated herein by reference for all purposes.

### BACKGROUND

### 1. Field of the Invention

One or more embodiments relate to a method of rendering object-based audio and an electronic device performing the method.

### 2. Description of the Related Art

Audio services have changed from mono and stereo services to 5.1 and 7.1 channels and to multi-channel services such as 9.1, 11.1, 10.2, 13.1, 15.1, and 22.2 channels that include upstream channels.

On the other hand, unlike the existing channel service, object-based audio service technology that regards one audio source as an object and stores/transmits/plays object-based audio related information such as an object-based audio signal and an object-based audio location and size is also being developed.

The above description has been possessed or acquired by the inventor(s) in the course of conceiving the present disclosure and is not necessarily an art publicly known before the present application is filed.

### SUMMARY

Embodiments provide a method of rendering object-based audio in calculating and processing a volume of sound according to a distance between a listener and object-based audio in a virtual reality (VR) environment by setting a minimum distance at which sound of object-based audio no longer increases.

Embodiments provide a method of effectively protecting a listener by preventing sound of object-based audio from becoming too loud and a method of rendering object-based audio naturally when a minimum distance is set based on a reference distance and a distance between the object-based audio and the listener is close less than or equal to the minimum distance.

However, the technical aspects are not limited to the aforementioned aspects, and other technical aspects may be present.

According to an aspect, there is provided a method of rendering object-based audio including identifying metadata of object-based audio, identifying an audio source distance between the object-based audio and a listener using the metadata, determining a minimum distance of the object-based audio to apply attenuation according to the audio source distance, based on a reference distance of the object-based audio in the metadata, and rendering the object-based audio using the audio source distance and the minimum distance.

The determining of the minimum distance may include determining the minimum distance as a value obtained by dividing the reference distance by a set integer.

The determining of the minimum distance may include determining a distance increased by a set gain as the minimum distance, compared to a gain of the object-based audio at the reference distance.

The rendering of the object-based audio may include determining a gain of the object-based audio based on the audio source distance and the reference distance, when the audio source distance exceeds the minimum distance, and rendering the object-based audio based on the gain of the object-based audio.

The rendering of the object-based audio may include determining a gain of the object-based audio when the object-based audio is at the minimum distance, when the audio source distance is less than or equal to the minimum distance, and rendering the object-based audio based on the gain of the object-based audio.

According to an aspect, there is provided a method of rendering object-based audio including identifying metadata of object-based audio, identifying an audio source distance between the object-based audio and a listener using the metadata, determining a minimum distance of the object-based audio to apply attenuation according to the audio source distance, based on a reference distance of the object-based audio in the metadata, determining a gain of the object-based audio by applying attenuation according to the audio source distance, based on the audio source distance and the reference distance, when the audio source distance exceeds the minimum distance, determining the gain of the object-based audio when the object-based audio is at the minimum distance, when the audio source distance is less than or equal to the minimum distance, and rendering the object-based audio based on the gain of the object-based audio.

The determining of the minimum distance may include determining the minimum distance as a value obtained by dividing the reference distance by a set integer.

The determining of the minimum distance may include determining a distance increased by a set gain as the minimum distance, compared to the gain of the object-based audio at the reference distance.

According to an aspect, there is provided an electronic device including a processor, wherein the processor is configured to identify metadata of object-based audio, identify an audio source distance between the object-based audio and a listener using the metadata, determine a minimum distance of the object-based audio to apply attenuation according to the audio source distance, based on a reference distance of the object-based audio in the metadata, and render the object-based audio using the audio source distance and the minimum distance.

The processor may be configured to determine the minimum distance as a value obtained by dividing the reference distance by a set integer.

The processor may be configured to determine a distance increased by a set gain as the minimum distance, compared to a gain of the object-based audio at the reference distance.

The processor may be configured to determine a gain of the object-based audio based on the audio source distance and the reference distance, when the audio source distance exceeds the minimum distance, and render the object-based audio based on the gain of the object-based audio.

The processor may be configured to determine a gain of the object-based audio when the object-based audio is at the minimum distance, when the audio source distance is less than or equal to the minimum distance, and render the object-based audio based on the gain of the object-based audio.

Additional aspects of embodiments will be set forth in part in the description which follows and, in part, will be apparent from the description, or may be learned by practice of the disclosure.

According to embodiments, using a method of rendering object-based audio and an electronic device, clipping of an output signal from object-based audio rendered according to a distance of the object-based audio may be prevented or improved, and hearing damage to a listener may be prevented or improved.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a control workflow and a rendering workflow of an electronic device according to various embodiments;

FIG. 2 is a diagram illustrating a renderer pipeline according to various embodiments;

FIG. 3 is a block diagram illustrating an electronic device according to various embodiments;

FIG. 4 is a flowchart illustrating an operation of a method of rendering object-based audio according to various embodiments;

FIG. 5 is a flowchart illustrating an operation of a method of rendering object-based audio based on an audio source distance and a minimum distance according to various embodiments;

FIG. 6 is a diagram illustrating a gain of object-based audio according to a distance according to various embodiments; and

FIGS. 7A, 7B, and 7C are diagrams illustrating a gain of object-based audio determined based on a maximum distance determined according to various embodiments.

### DETAILED DESCRIPTION

The following detailed structural or functional description is provided as an example only and various alterations and modifications may be made to examples. Accordingly, examples are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions.

For example, according to an example, the module may be implemented in a form of an application-specific integrated circuit (ASIC).

The term “unit” or the like used herein may refer to a software or hardware component, such as a field-programmable gate array (FPGA) or an application-specific integrated circuit (ASIC), and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the examples will be described in detail with reference to the accompanying drawings. When describing the examples with reference to the accompanying drawings, like reference numerals refer to like components and a repeated description related thereto will be omitted.

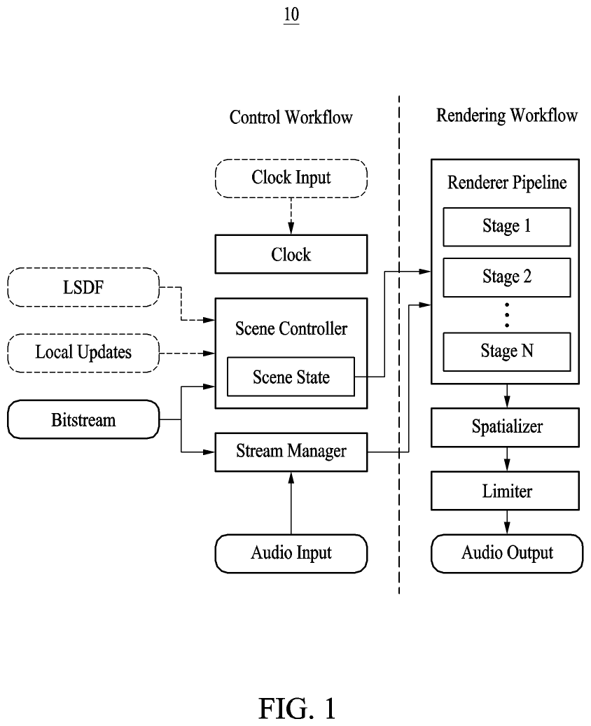

FIG. 1 is a diagram illustrating a control workflow and a rendering workflow of an electronic device according to various embodiments.

According to an embodiment, an electronic device may render object-based audio using an object-based audio signal and metadata. For example, the electronic device may refer to a renderer.

For example, the electronic device may perform real-time audioization of an audio scene having 6 degrees of freedom (DoF) in which a user may directly interact with an entity of the audio scene. The electronic device may render virtual reality (VR) or augmented reality (AR) scenes. In the case of VR or AR scenes, the electronic device may obtain the metadata and audio scene information from a bitstream. In the case of an AR scene, the electronic device may obtain listening space information where a user is located from a listener space description format (LSDF) file.

As shown in FIG. 1, the electronic device may output audio through a control workflow and a rendering workflow.

The control workflow is an entry point of the renderer, and the electronic device may interface with an external system and components of the external system through the control workflow. The electronic device may adjust a state of entities of the 6-DoF scene and implement an interactive interface, using a scene controller in the control workflow.

The electronic device may control a scene state. The scene state may reflect a current state of all scene objects including audio elements, transformations/anchors, and geometry. The electronic device may generate all objects of the entire scene before the rendering starts and may update to a state in which a desired scene configuration is reflected in the metadata of all objects when the playback starts.

The electronic device may provide an integrated interface for renderer components to access an audio stream connected to an audio element of the scene state, using a stream manager. The audio stream may be input as a printed circuit board (PCB) float sample. A source of the audio stream may be, for example, a decoded moving picture experts group (MPEG)-H audio stream or locally captured audio.

A clock may provide the current scene time in seconds by providing the interface for the renderer components. A clock input may be, for example, a synchronization signal from another sub-system or an internal clock of the renderer.

The rendering workflow may generate an audio output signal. For example, the audio output signal may be a pulse code modulation (PCM) float. The rendering workflow may be separated from the control workflow. The stream manager to provide the scene state and an input audio stream to transmit all changes of the 6-DoF scene may access the rendering workflow for communication between the two workflows (the control workflow and the rendering workflow).

A renderer pipeline may audioize the input audio stream provided by the stream manager, based on the current scene state. For example, the rendering may be performed along a sequential pipeline, such that individual renderer stages implement independent perceptual effects and use processing of previous and subsequent stages.

A spatializer may terminate the renderer pipeline and audioize an output of the renderer stage into a single output audio stream suitable for a desired playback method (e.g., binaural or loudspeaker playback).

A limiter may provide a clipping protection function for the audioized output signal.

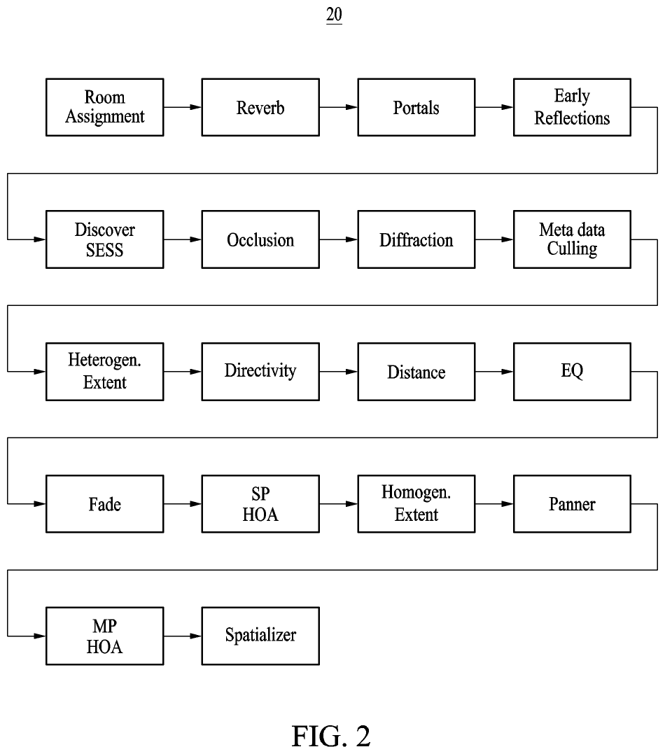

FIG. 2 is a diagram illustrating a renderer pipeline according to various embodiments.

For example, each renderer stage of the renderer pipeline may be performed according to a set order. For example, the renderer pipeline may include stages of room assignment, reverb, portal, early reflection, discover spatially extended sound source (SESS), occlusion, diffraction, culling of the metadata, heterogeny, extent, directivity, distance, equalizer (EQ), fade, single point higher-order ambisonics (SP HOA), homogen, extent, panner, and multi point higher-order ambisonics (MP HOA).

For example, the electronic device may render a gain, propagation delay, and medium absorption of the object-based audio, according to the distance between the object-based audio and the listener in the rendering workflow (e.g., the rendering workflow of FIG. 1). For example, the electronic device may determine at least one of the gain, propagation delay, or medium absorption of the object-based audio in the distance stage of the renderer pipeline.

In the distance stage, the electronic device may calculate a distance between each render item (RI) and the listener and may interpolate a distance between update routine calls of the object-based audio stream based on a constant velocity model. The RI may refer to all audio elements in the renderer pipeline.

The electronic device may apply the propagation delay to a signal related to the RI to generate a physically accurate delay and Doppler effect.

The electronic device may model a frequency-independent attenuation of the audio element due to geometric diffusion of source energy, applying a distance attenuation. The electronic device may use a model considering the size of the audio source for the distance attenuation of a geometrically extended audio source.

The electronic device may apply the medium absorption to the object-based audio, by modeling the frequency-dependent attenuation of the audio element related to absorption features of air.

The electronic device may determine a gain of the object-based audio by applying the distance attenuation according to the distance between the object-based audio and the listener. The electronic device may apply the distance attenuation due to the geometric diffusion, using a parametric model considering the size of the audio source.

When the audio is played in the 6-DoF environment, a sound level of the object-based audio may vary depending on the distance, and the size of the object-based audio may be determined according to the 1/r law in which the size decreases in inverse proportion to the distance. For example, the electronic device may determine the size of the object-based audio according to the 1/r law in a region where the distance between the object-based audio and the listener is greater than a minimum distance and less than a maximum distance. The minimum distance and the maximum distance may refer to distances set to apply the attenuation, propagation delay, and atmospheric absorption effect according to the distance.

For example, the electronic device may identify a location of the listener (e.g., three-dimensional (3D) spatial information), a location of the object-based audio (e.g., the 3D spatial information), and the speed of the object-based audio, using the metadata. The electronic device may calculate the distance between the object-based audio and the listener, using the location of the listener and the location of the object-based audio.

The size of an audio signal transmitted to the listener may vary depending on the distance between the audio source (e.g., the location of the object-based audio) and the listener. For example, in general, a sound level transmitted to the listener located at a distance of 2 meters (m) from the audio source may be less than the sound level transmitted to the listener located at a distance of 1 m from the audio source. In a free field environment, the sound level may be reduced by a ratio of 1/r (r is the distance between the object-based audio and the listener). When the distance between the audio source and the listener is doubled, the sound level heard by the listener may be reduced by about 6 decibels (dB).

The law about the attenuation of the distance and sound level may be applied to the 6-Dof VR environment. The electronic device may use a method of decreasing the size of one object-based audio signal when the distance is far from the listener and increasing the size of one object-based audio signal when the distance is close to the listener.

For example, assuming that a sound pressure level heard by the listener is 0 dB when the listener is 1 m away from the object-based audio, when the sound pressure level is changed to −6 dB when the listener is 2 m away from the object-based audio, the listener may feel that the sound pressure naturally decreases.

For example, when the distance between the object-based audio and the listener is greater than the minimum distance and less than the maximum distance, the electronic device may determine a gain of the object-based audio according to Equation 1 below. In Equation 1, the “reference distance” denotes a reference distance and the “current distance” denotes a distance between the object-based audio and the listener. The reference distance may refer to a distance at which the gain of the object-based audio is 0 dB and may be set differently for each object-based audio. For example, the metadata may include the reference distance of the object-based audio.

Gain [dB]=20 log(reference_distance/current_distance) [Equation 1]

The electronic device may determine the gain of the object-based audio by considering the atmospheric absorption effect according to the distance. A medium attenuation may correspond to frequency-dependent attenuation of an audio source due to geometric energy diffusion. The electronic device may model the medium attenuation according to the atmospheric absorption effect by modifying an EQ field in the distance stage. Depending on the medium attenuation, the electronic device may apply a low-pass effect to the object-based audio that is far away from the listener.

According to Equation 1, when the gain of the object-based audio is determined, when the distance between the object-based audio and the listener is close, the sound level of the object-based audio increases rapidly and clipping may occur. The electronic device may determine the minimum distance of the object-based audio based on the reference distance to prevent or alleviate clipping generation as the distance between the object-based audio and the listener decreases.

In another example, the electronic device may limit the size of an audio output that is output in the limiter stage of the rendering workflow.

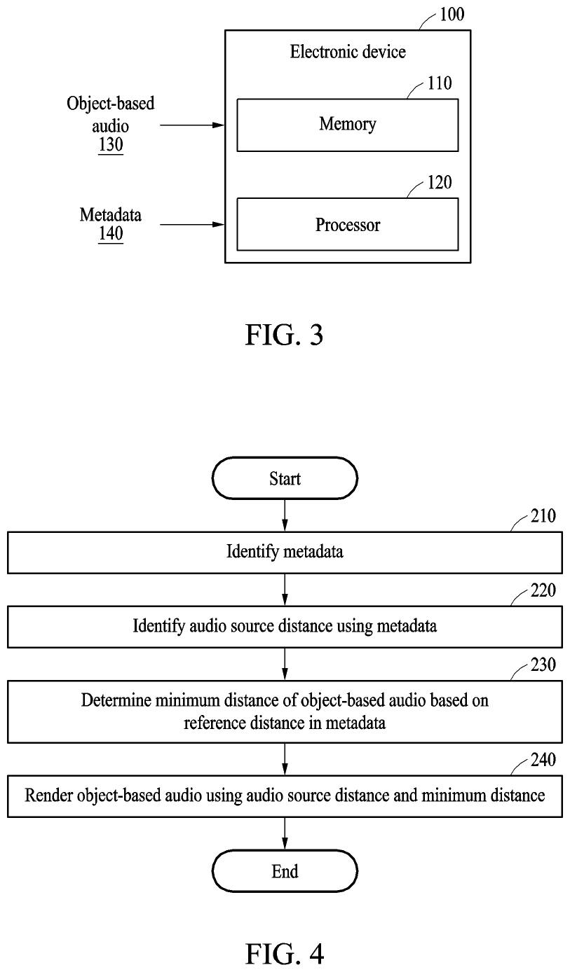

FIG. 3 is a block diagram illustrating an electronic device 100 according to various embodiments.

Referring to FIG. 3, the electronic device 100 may include a memory 110 and a processor 120 according to various embodiments.

The memory 110 may store various pieces of data used by at least one component (e.g., a processor or a sensor module) of the electronic device 100. The various pieces of data may include, for example, software (e.g., a program) and input data or output data for a command related thereto. The memory 110 may include volatile memory or non-volatile memory.

The processor 120 may execute, for example, software (e.g., a program) to control at least one other component (e.g., a hardware or software component) of the electronic device 100 connected to the processor 120, and may perform various data processing or computations. According to an embodiment, as at least a part of the data processing or computations, the processor 120 may store a command or data received from another component (e.g., a sensor module or a communication module) in a volatile memory, process the command or the data stored in the volatile memory, and store resulting data in a non-volatile memory. According to an embodiment, the processor 120 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with the main processor. For example, when the electronic device 100 includes a main processor and an auxiliary processor, the auxiliary processor may be adapted to consume less power than the main processor or to be specific to a specified function. The auxiliary processor may be implemented separately from the main processor or as a part of the main processor.

Regarding operations described below, the electronic device 100 may perform the operations using the processor 120. For example, the electronic device 100 may identify object-based audio 130 and metadata 140 using the processor 120 and determine a gain of the object-based audio 130. In another example, the electronic device 100 may further include a separate module (not shown) or block (not shown) for determining the gain (or volume, volume level, sound level) of the object-based audio 130 according to distance. For example, the electronic device 100 may further include a renderer (not shown) for rendering the object-based audio 130, and the renderer of the electronic device 100 may render the object-based audio 130 using the object-based audio 130 and the metadata 140.

The electronic device 100 may identify the object-based audio 130 and the metadata 140 of the object-based audio 130. The metadata 140 may include information related to the object-based audio 130. For example, the metadata 140 may include at least one of the 3D location information, volume information, reference distance information, minimum distance information, maximum distance information of the object-based audio 130, or a combination thereof.

The reference distance may refer to a distance at which the gain of the object-based audio 130 is 0 dB and may refer to a reference for applying attenuation according to distance. The minimum distance and the maximum distance may refer to distances for applying a distance attenuation model. For example, when an audio source distance between the object-based audio 130 and the listener is greater than or equal to the minimum distance and less than or equal to the maximum distance, the electronic device 100 may determine the gain of the object-based audio 130 by applying the distance attenuation model (e.g., the distance attenuation according to Equation 1 and the distance attenuation according to the 1/r law).

The electronic device 100 may determine the minimum distance of the object-based audio 130 based on the reference distance. For example, the electronic device 100 may determine the minimum distance as a value obtained by dividing the reference distance of the object-based audio 130 by a set integer. As shown in Equation 2 below, the electronic device 100 may determine the minimum distance (minimum_distance) as a value obtained by dividing the reference distance (reference_distance) by a set integer A.

minimum_distance=reference_distance/A [Equation 2]

For example, when the set integer is “5”, the electronic device 100 may determine the minimum distance (minimum distance of object) according to the reference distance (reference distance of object) of each source of object-based audio 130 as shown in Table 1 below.

TABLE 1

| | reference distance of object (meter) | | | | | | | | | |
|---|---|---|---|---|---|---|---|---|---|---|
| | 1 | 2 | 4 | 5 | 10 | 20 | 50 | 90 | 100 | 300 |
| minimum distance | 0.2 | 0.4 | 0.8 | 1 | 2 | 4 | 10 | 18 | 20 | 60 |
| of object (meter) | | | | | | | | | | |

When the set integer is “10”, the electronic device 100 may determine the minimum distance (minimum distance of object) according to the reference distance (reference distance of object) of the object-based audio 130 as shown in Table 2 below.

TABLE 2

| | reference distance of object [m] | | | | | | | | |
|---|---|---|---|---|---|---|---|---|---|
| | 1 | 2 | 5 | 10 | 20 | 50 | 100 | 200 | 500 |
| minimum distance by | 0.1 | 0.2 | 0.5 | 1 | 2 | 5 | 10 | 20 | 50 |
| proposed method [m] | | | | | | | | | |

Depending on the type of the object-based audio 130, when the audio source distance between the object-based audio 130 and the listener is very close (e.g., about 0.2 meters (m)), a case in which the gain of the object-based audio 130 should be determined to be large according to the distance attenuation model or a case in which the gain of the object-based audio 130 should be limited without applying the distance attenuation model may occur. For example, when the object-based audio 130 is “mosquito sound” and the audio source distance between the object-based audio 130 and the listener is about 0.2 m, the electronic device 100 may need to determine the gain of the object-based audio 130 to be large according to the distance attenuation model and play the object-based audio 130 to the listener. On the other hand, when the object-based audio 130 is “thunder sound” and the audio source distance between the object-based audio 130 and the listener is about 0.2 m, hearing damage to the listener may occur and clipping may occur when the gain of the object-based audio 130 is determined according to the distance attenuation model. The electronic device 100 may determine the gain of each object-based audio 130 according to the distance attenuation model by determining the minimum distance based on the reference distance.

For example, the electronic device 100 may determine a distance increased by a set gain as the minimum distance, compared to the gain of the object-based audio 130 at the reference distance. For example, the electronic device 100 may determine a distance increased by 12 dB from the gain of the object-based audio 130 at the reference distance as the minimum distance. Referring to Equation 1, the minimum distance increased by 12 dB than the gain of the object-based audio 130 at the reference distance may be about ¼ times the reference distance.

For example, when a distance increased by 6 dB, 12 dB, or 18 dB than the gain of the object-based audio 130 at the reference distance is determined as the minimum distance, the electronic device 100 may determine a distance that is ½, ¼, or ⅛ times the reference distance as the minimum distance.

In the above example, increasing the gain of the object-based audio 130 by the set gain from the gain of object-based audio 130 may mean that the sound size of the object-based audio 130 increases by a set size from the sound size at the reference distance.

Table 3 below may show, when the integer set in Equation 1 is “5”, the reference distance (reference distance of object), the minimum distance (minimum distance of object) determined based on the reference distance, the gain (gain dB at 0.2 m where minimum distance is 0.2 m (dB)—A) of the object-based audio 130 when the minimum distance of the object-based audio 130 is set to 0.2 m, and the gain (gain dB at 0.2 m where minimum distance is calculated by our proposal (dB)—B) of the object-based audio 130 when the minimum distance of the object-based audio 130 is determined based on the reference distance.

TABLE 3

| | reference distance of object (meter) | | | | | | | | | |
|---|---|---|---|---|---|---|---|---|---|---|
| | 1 | 2 | 4 | 5 | 10 | 20 | 50 | 90 | 100 | 300 |
| minimum | 0.2 | 0.4 | 0.8 | 1 | 2 | 4 | 10 | 18 | 20 | 60 |
| distance | | | | | | | | | | |
| of object | | | | | | | | | | |
| (meter) | | | | | | | | | | |
| gain dB at | 13.98 | 20.00 | 26.02 | 27.96 | 33.98 | 40.00 | 47.96 | 53.06 | 53.98 | 63.52 |
| 0.2 m where | | | | | | | | | | |
| minimum | | | | | | | | | | |
| distance is | | | | | | | | | | |
| 0.2 m (dB) − A | | | | | | | | | | |
| gain dB at | 13.98 | 13.98 | 13.98 | 13.98 | 13.98 | 13.98 | 13.98 | 13.98 | 13.98 | 13.98 |
| 0.2 m where | | | | | | | | | | |
| minimum | | | | | | | | | | |
| distance is | | | | | | | | | | |
| calculated by | | | | | | | | | | |
| our proposal | | | | | | | | | | |
| (dB) − B | | | | | | | | | | |
| A − B (dB) | 0.00 | 6.02 | 12.04 | 13.98 | 20.00 | 26.02 | 33.98 | 39.08 | 40.00 | 49.54 |

As shown in Table 3, when the minimum distances of the object-based audio 130 are all set to 0.2 m and the audio source distance between the object-based audio 130 and the listener is 0.2 m, the gain of the object-based audio 130 may be determined as 13.98 dB, 20.00 dB, 26.02 dB, etc. When the minimum distance of the object-based audio 130 is determined based on the reference distance and the audio source distance between the object-based audio 130 and the listener is 0.2 m, the gain of the object-based audio 130 may be determined as 13.98 dB.

For example, in the case of the object-based audio 130 with a reference distance of 10 m, when the minimum distance is 0.2 m identically set to all sources of object-based audio 130 and the audio source distance between the object-based audio 130 and the listener is 0.2 m, a high sound pressure level of about 33.98 dB may be obtained. Under the same conditions, when the minimum distance determined based on the reference distance is 2.0 m and the audio source distance between the object-based audio 130 and the listener is 0.2 m, a relatively low sound pressure level of about 13.98 dB may be obtained.

As shown in Table 3, the electronic device 100 may prevent or improve clipping generation and protect the hearing of the listener by determining the minimum distance of the object-based audio 130 based on the reference distance and determining the gain of the object-based audio 130.

Table 4 below may show, when the integer set in Equation 1 is “10”, the reference distance (reference distance of object), the minimum distance (minimum distance of object) determined based on the reference distance, the gain (gain dB at 0.2 m where minimum distance is 0.2 m (dB)—A) of the object-based audio 130 when the minimum distance of the object-based audio 130 is set to 0.2 m, and the gain (gain dB at 0.2 m where minimum distance is calculated by our proposal (dB)—B) of the object-based audio 130 when the minimum distance of the object-based audio 130 is determined based on the reference distance.

TABLE 4

| | reference distance of object [m] | | | | | | | | |
|---|---|---|---|---|---|---|---|---|---|
| | 1 | 2 | 5 | 10 | 20 | 50 | 100 | 200 | 500 |
| minimum distance | 0.1 | 0.2 | 0.5 | 1 | 2 | 5 | 10 | 20 | 50 |
| of object (meter) | | | | | | | | | |
| gain dB at 0.2 m | 13.98 | 20.00 | 27.96 | 33.98 | 40.00 | 47.96 | 53.98 | 60.00 | 67.96 |
| where | | | | | | | | | |
| minimum distance is | | | | | | | | | |
| 0.2 m (dB) − A | | | | | | | | | |
| gain dB at 0.2 m | 20.00 | 20.00 | 20.00 | 20.00 | 20.00 | 20.00 | 20.00 | 20.00 | 20.00 |
| where | | | | | | | | | |
| minimum distance is | | | | | | | | | |
| calculated by our | | | | | | | | | |
| proposal (dB) − B | | | | | | | | | |
| A − B [dB] | −6.02 | 0.00 | 7.96 | 13.98 | 20.00 | 27.96 | 33.98 | 40.00 | 47.96 |

In relation to Table 4, similar to the description with reference to Table 3, when the audio source distance between the object-based audio 130 and the listener is close (e.g., 0.2 m), clipping generation may be prevented or improved, and the hearing of the listener may be protected by determining the minimum distance of the object-based audio 130 based on the reference distance and determining the gain of the object-based audio 130.

The electronic device 100 may render the object-based audio 130 based on the audio source distance and the minimum distance. For example, the electronic device 100 may determine the gain of the object-based audio 130 based on the audio source distance and the minimum distance.

For example, when the audio source distance exceeds the minimum distance, the electronic device 100 may determine the gain of the object-based audio 130 based on the audio source distance and the reference distance. For example, the electronic device 100 may determine the gain of the object-based audio 130 according to Equation 1.

When the audio source distance is less than or equal to the minimum distance, the electronic device 100 may determine the gain of the object-based audio 130 when the object-based audio 130 is at the minimum distance. Even when the audio source distance is less than or equal to the minimum distance, the electronic device 100 may determine the gain of the object-based audio 130 when the object-based audio 130 is at the minimum distance as the gain of the object-based audio 130 of which the audio source distance is less than or equal to the minimum distance.

FIG. 4 is a flowchart illustrating an operation of a method of rendering the object-based audio 130 according to various embodiments.

Referring to FIG. 4, in operation 210, the electronic device 100 according to various embodiments may identify the metadata 140. For example, the metadata 140 may include at least one of the 3D location information, volume information, reference distance information, minimum distance information, maximum distance information of the object-based audio 130, or a combination thereof.

In operation 220, the electronic device 100 may identify an audio source distance using the metadata 140. For example, the electronic device 100 may calculate the audio source distance using the location of the listener and the location of the object-based audio 130.

In operation 230, the electronic device 100 may determine a minimum distance of the object-based audio 130 based on a reference distance in the metadata 140. For example, the electronic device 100 may determine a value obtained by dividing the reference distance by a set integer as the minimum distance. For example, the electronic device 100 may determine a distance increased by a set gain as the minimum distance, compared to the gain of the object-based audio 130 at the reference distance.

In operation 240, the electronic device 100 may render the object-based audio 130 using the audio source distance and the minimum distance. For example, the electronic device 100 may determine the gain of the object-based audio 130 using the audio source distance and the minimum distance. The electronic device 100 may render the object-based audio 130 based on the gain of the object-based audio 130.

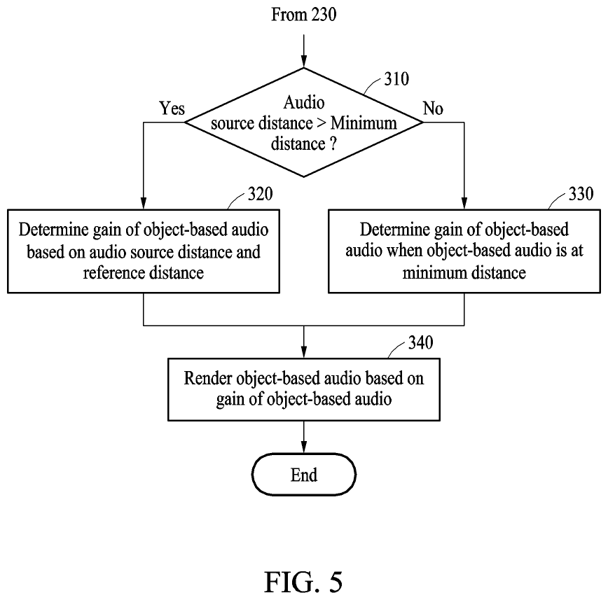

FIG. 5 is a flowchart illustrating an operation of a method of rendering the object-based audio 130 based on an audio source distance and a minimum distance according to various embodiments.

In operation 310, the electronic device 100 may compare an audio source distance with a minimum distance.

For example, in operation 320, when the audio source distance exceeds the minimum distance, the electronic device 100 may determine the gain of the object-based audio 130 based on the audio source distance and a reference distance. The electronic device 100 may determine the gain of the object-based audio 130 according to distance attenuation model (e.g., Equation 1, 1/r law). The electronic device 100 may determine the gain of the object-based audio 130 according to Equation 1.

For example, the electronic device 100 may determine the gain of the object-based audio 130 according to the distance attenuation model, when the audio source distance exceeds the minimum distance and is less than a maximum distance. For example, when the audio source distance is greater than or equal to the maximum distance, the electronic device 100 may not render the object-based audio 130 or not output an audio signal.

For example, in operation 330, when the audio source distance is less than or equal to the minimum distance, the electronic device 100 may determine a gain when the object-based audio 130 is at the minimum distance as the gain of the object-based audio 130.

In operation 340, the electronic device 100 may render the object-based audio 130 based on the gain of the determined object-based audio 130. The electronic device 100 may determine the size of an output audio signal based on the gain of the object-based audio 130.

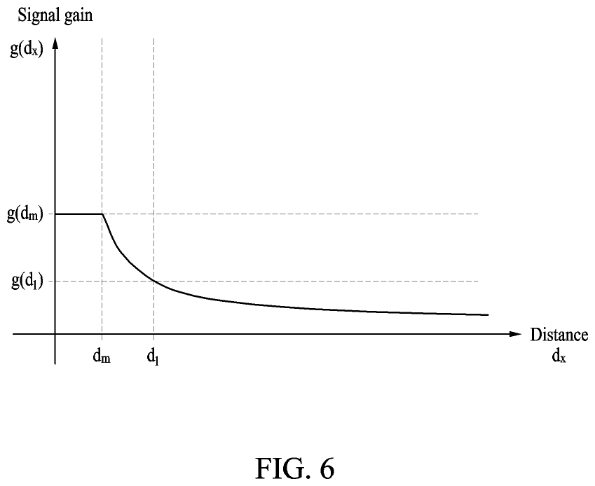

FIG. 6 is a diagram illustrating a gain of the object-based audio 130 according to distance according to various embodiments.

Referring to FIG. 6, when an audio source distance (e.g., distance dₓ in FIG. 6) is less than a minimum distance (e.g., dₘ in FIG. 6), it may be confirmed that the gain (e.g., signal gain g(dₓ)) of the object-based audio 130 is constant as g(dₘ) regardless of the audio source distance. When the audio source distance is less than or equal to the minimum distance, the electronic device 100 may determine the gain of the object-based audio 130 as the gain g(dₘ) when the object-based audio 130 is at the minimum distance.

When the audio source distance exceeds the minimum distance, the electronic device 100 may determine the gain of the object-based audio 130 according to distance attenuation model. In FIG. 6, when the audio source distance is d₁ greater than the minimum distance dₙ, the electronic device 100 may determine the gain of the object-based audio 130 as g(d₁).

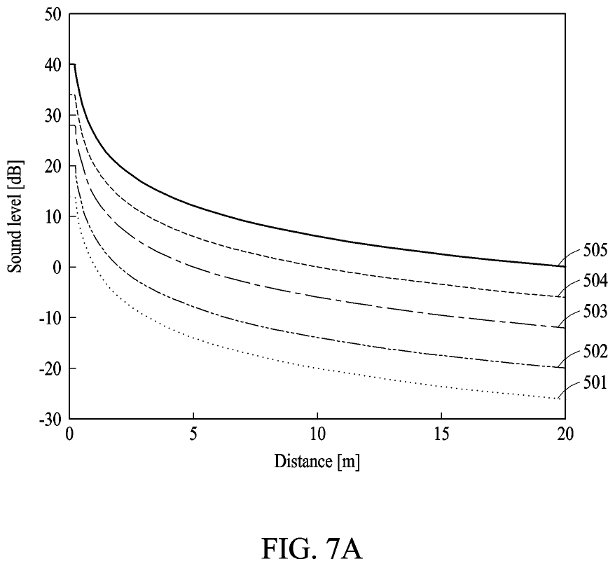

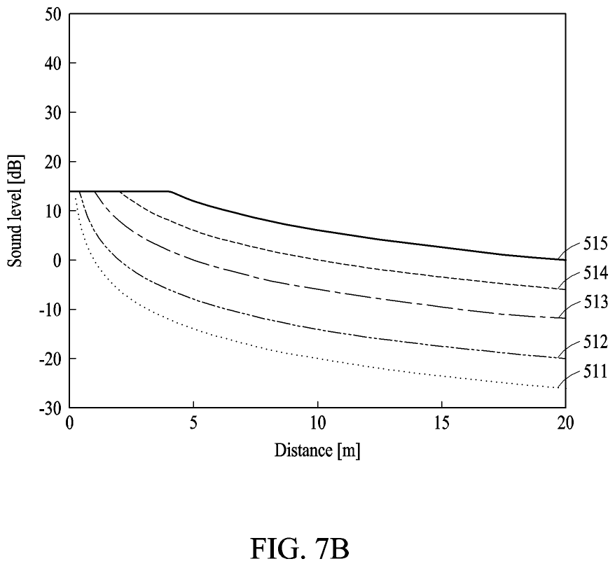

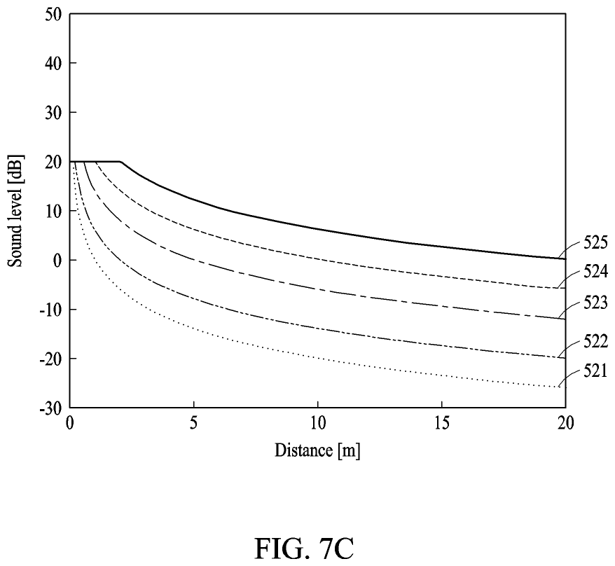

FIGS. 7A, 7B, and 7C are diagrams illustrating a gain of the object-based audio 130 determined based on a maximum distance determined according to various embodiments.

FIG. 7A may show the gain of the object-based audio 130 according to distance when a minimum distance of the object-based audio 130 is determined as a constant value (e.g., 0.2 m) regardless of a reference distance, FIG. 7B may show the gain of the object-based audio 130 according to distance when the integer set in Equation 2 is “5”, and FIG. 7C may show the gain of the object-based audio 130 according to distance when the integer set in Equation 2 is “10”.

In FIGS. 7A, 7B, and 7C, graphs 501, 511, and 521 may show the gain of the object-based audio 130 with the reference distance of 1 m, graphs 502, 512, and 522 may show the gain of the object-based audio 130 with the reference distance of 2 m, graphs 503, 513, and 523 may show the gain of the object-based audio 130 with the reference distance of 5 m, graphs 504, 514, and 524 may show the gain of the object-based audio 130 with the reference distance of 10 m, and graphs 505, 515, and 525 may show the gain of the object-based audio 130 with the reference distance of 20 m.

Referring to graphs 501, 502, 503, 504, and 505 shown in FIG. 7A, when the minimum distance of the object-based audio 130 is set equally as 0.2 m, when the audio source distance is less than or equal to the minimum distance, it may be seen that the gains of the object-based audio 130 are each high (e.g., the gain of the object-based audio 130 with the reference distance of 20 m is about 40 dB) according to the reference distance.

Referring to graphs 511, 512, 513, 514, and 515 in FIG. 7B, it may be seen that the gain of the object-based audio 130 is about 13.98 dB when the audio source distance is less than or equal to the minimum distance. For example, referring to the graph 515, when the audio source distance is less than or equal to 4 m, which is determined as ⅕ times the reference distance of 20 m, the electronic device 100 may determine the gain of the object-based audio 130 to be about 13.98 dB.

Referring to graphs 521, 522, 523, 524, and 525 in FIG. 7C, it may be seen that the gain of the object-based audio 130 is about 20 dB when the audio source distance is less than or equal to the minimum distance. For example, referring to the graph 525, when the audio source distance is less than or equal to 2 m, which is determined as 1/10 times the reference distance of 20 m, the electronic device 100 may determine the gain of the object-based audio 130 to be about 20 dB.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory (ROM) or a random access memory (RAM), or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, for example, magnetic media such as hard disks, floppy disks, and magnetic tape, optical media such as compact disc ROMs (CD-ROMs) or digital versatile discs (DVDs), magneto-optical media such as floptical disks, ROMs, RAMs, flash memories, erasable programmable ROMs (EPROMs), or electrically erasable programmable ROMs (EEPROMs). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multi-tasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed embodiments, can be made.

What is claimed is:

1. A method of rendering object-based audio, the method comprising:
identifying metadata of object-based audio;
identifying an audio source distance between the object-based audio and a listener using the metadata;
determining a minimum distance of the object-based audio to apply attenuation according to the audio source distance, based on a reference distance of the object-based audio in the metadata; and
rendering the object-based audio using the audio source distance and the minimum distance.

2. The method of claim 1, wherein the determining of the minimum distance comprises determining the minimum distance as a value obtained by dividing the reference distance by a set integer.

3. The method of claim 1, wherein the determining of the minimum distance comprises determining a distance increased by a set gain as the minimum distance, compared to a gain of the object-based audio at the reference distance.

4. The method of claim 1, wherein the rendering of the object-based audio comprises:
determining a gain of the object-based audio based on the audio source distance and the reference distance, when the audio source distance exceeds the minimum distance; and
rendering the object-based audio based on the gain of the object-based audio.

5. The method of claim 1, wherein the rendering of the object-based audio comprises:
determining a gain of the object-based audio when the object-based audio is at the minimum distance, when the audio source distance is less than or equal to the minimum distance; and
rendering the object-based audio based on the gain of the object-based audio.

6. A method of rendering object-based audio, the method comprising:
identifying metadata of object-based audio;
identifying an audio source distance between the object-based audio and a listener using the metadata;
determining a minimum distance of the object-based audio to apply attenuation according to the audio source distance, based on a reference distance of the object-based audio in the metadata;
determining a gain of the object-based audio by applying attenuation according to the audio source distance, based on the audio source distance and the reference distance, when the audio source distance exceeds the minimum distance;
determining the gain of the object-based audio when the object-based audio is at the minimum distance, when the audio source distance is less than or equal to the minimum distance; and
rendering the object-based audio based on the gain of the object-based audio.

7. The method of claim 6, wherein the determining of the minimum distance comprises determining the minimum distance as a value obtained by dividing the reference distance by a set integer.

8. The method of claim 6, wherein the determining of the minimum distance comprises determining a distance increased by a set gain as the minimum distance, compared to the gain of the object-based audio at the reference distance.

9. An electronic device comprising:
a processor,
wherein the processor is configured to:
identify metadata of object-based audio;
identify an audio source distance between the object-based audio and a listener using the metadata;
determine a minimum distance of the object-based audio to apply attenuation according to the audio source distance, based on a reference distance of the object-based audio in the metadata; and
render the object-based audio using the audio source distance and the minimum distance.

10. The electronic device of claim 9, wherein the processor is configured to determine the minimum distance as a value obtained by dividing the reference distance by a set integer.

11. The electronic device of claim 9, wherein the processor is configured to determine a distance increased by a set gain as the minimum distance, compared to a gain of the object-based audio at the reference distance.

12. The electronic device of claim 9, wherein the processor is configured to:
determine a gain of the object-based audio based on the audio source distance and the reference distance, when the audio source distance exceeds the minimum distance; and
render the object-based audio based on the gain of the object-based audio.

13. The electronic device of claim 9, wherein the processor is configured to:
determine a gain of the object-based audio when the object-based audio is at the minimum distance, when the audio source distance is less than or equal to the minimum distance; and
render the object-based audio based on the gain of the object-based audio.
